(19) United States
(12) Patent Application Publication
(10) Pub. No.: US 2015/0035814 A1
(43) Pub. Date: Feb. 5, 2015

(54) VEHICLE-MOUNTED ELECTRONIC EQUIPMENT OPERATION DEVICE

(71) Applicant: Panasonic Corporation, Osaka (JP)

(72) Inventor: Koichi Nishimura, Kanagawa (JP)

(21) Appl. No.: 14/387,705

(22) PCT Filed: Mar. 22, 2013
(86) PCT No.: PCT/JP2013/001950

§ 371 Date: Sep. 24, 2014

(30) Foreign Application Priority Data
Mar. 27, 2012 (JP) 2012-070814

(51) Int. Cl. G09G 3/20

(52) U.S. Cl. CPC G09G 3/2007; G09G 2320/0626; G09G 2320/103; G09G 2380/10
USPC 345/207

(57) ABSTRACT

The present invention relates to a vehicle-mounted electronic equipment operation device and is intended to improve safety. A control unit 8 has a function of displaying an operating unit 12 at at least part of an outer peripheral portion of a display unit 9 and displaying an image from a camera 5 at a central portion of the display unit 9. When the control unit 8 displays the operating unit 12 at at least part of the outer peripheral portion of the display unit 9 by way of operation of a display select switch 10, the control unit 8 also displays the image from the camera 5 at the central portion of the display unit 9, while lowering brightness of the camera image 13 at an initial stage of display of the camera image 13 and increasing the brightness afterward.

### TECHNICAL FIELD

The present invention relates to a vehicle-mounted electronic equipment operation device for operating an audio device, a radio receiver, or the like in a vehicle.

### BACKGROUND ART

This type of vehicle-mounted electronic equipment operation device includes a display unit, a control unit connected to the display unit, and a camera and a display select switch connected to the control unit, and the control unit has a function of displaying an operating unit and an image from the camera at the display unit (for example, the following Patent Literature 1).

### CITATION LIST

### Patent Literature

Patent Literature 1: Japanese Patent Laid-Open No. 10-47978

### SUMMARY OF INVENTION

### Technical Problem

In the above-described example of the conventional art, the vehicle-mounted electronic equipment operation device is configured so that when a driver operates the operating unit displayed at the display unit, a camera image is displayed at the display unit so as to prevent the driver from failing to confirm the front side by being distracted by the operation.

That is, when the driver operates the operating unit in the display unit, because the driver can also confirm the front side by the camera image displayed at the display unit, it is possible to improve safety.

However, when the camera image is displayed at the display unit at the same time as display of the operating unit, there is a case where the image is too bright, which may lead to a rather dangerous situation.

For example, when an image of the sun at the front side of the vehicle is displayed or an image of a head light of a vehicle coming from the opposite direction is displayed, the camera image to be displayed at the display unit becomes too bright. When the driver fixes his eyes on the display unit to operate the operating unit at this time, this brightness may lead to a dangerous situation.

It is therefore an object of the present invention to improve safety when a driver operates a vehicle-mounted electronic equipment operation device.

### Solution to Problem

To achieve this object, a vehicle-mounted electronic equipment operation device according to the present invention includes a display unit, a control unit connected to the display unit, and a camera and a display select switch connected to the control unit, wherein the control unit has a function of displaying an operating unit at at least part of an outer peripheral portion of the display unit and displaying an image from the camera at a central portion of the display unit, wherein, when the control unit displays the operating unit at at least part of the outer peripheral portion of the display unit by way of operation of the display select switch, the control unit also displays the image from the camera at the central portion of the display unit, while lowering brightness of the camera image at an initial stage of display of the camera image and increasing the brightness of the camera image afterward to thereby achieve a desired object.

### Advantageous Effect of Invention

As described above, because the vehicle-mounted electronic equipment operation device according to the present invention includes a display unit, a control unit connected to the display unit, and a camera and a display select switch connected to the control unit, and the control unit has a function of displaying an operating unit at at least part of an outer peripheral portion of the display unit and displaying an image from the camera at a central portion of the display unit, when the control unit displays the operating unit at at least part of the outer peripheral portion of the display unit by way of operation of the display select switch, the control unit also displays the image from the camera at the central portion of the display unit, while lowering brightness of the camera image at an initial stage of display of the camera image and increasing the brightness of the camera image afterward, it is possible to improve safety when a driver operates the vehicle-mounted electronic equipment operation device.

That is, because the present invention is configured so that at an initial stage of display of a camera image, brightness of the camera image is lowered, and the brightness of the camera image is increased afterward, a driver is less likely to feel that the image is too bright, and, as a result, it is possible to improve safety.

### BRIEF DESCRIPTION OF DRAWINGS

FIG. 1 illustrates a vehicle equipped with a vehicle-mounted electronic equipment operation device according to one embodiment of the present invention.

FIG. 2 is a control block diagram of the vehicle-mounted electronic equipment operation device.

FIG. 3 illustrates operation of the vehicle-mounted electronic equipment operation device.

FIG. 4 is a flowchart illustrating the operation of the vehicle-mounted electronic equipment operation device.

### DESCRIPTION OF EMBODIMENT

One embodiment of the present invention will be described below with reference to the accompanying drawings.

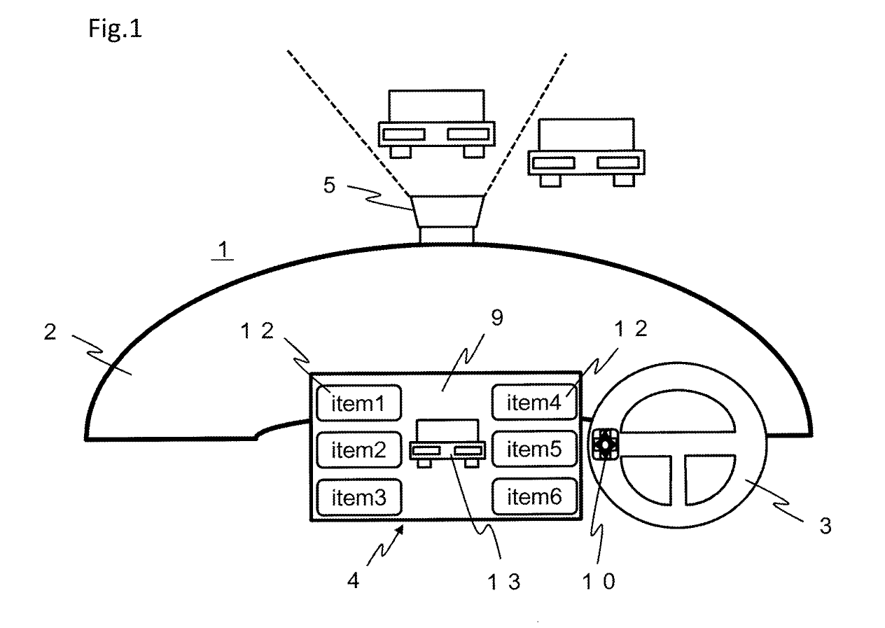

FIG. 1 illustrates a vehicle equipped with a vehicle-mounted electronic equipment operation device according to one embodiment of the present invention. FIG. 1 illustrates a vehicle 1 in which a handle 3 is provided at an anterior side of vehicle interior 2, and electronic equipment 4 is disposed at the side of the handle 3.

Further, at the front side of the electronic equipment 4 provided at the vehicle interior 2, a camera 5 is disposed to face the front side outside the vehicle.

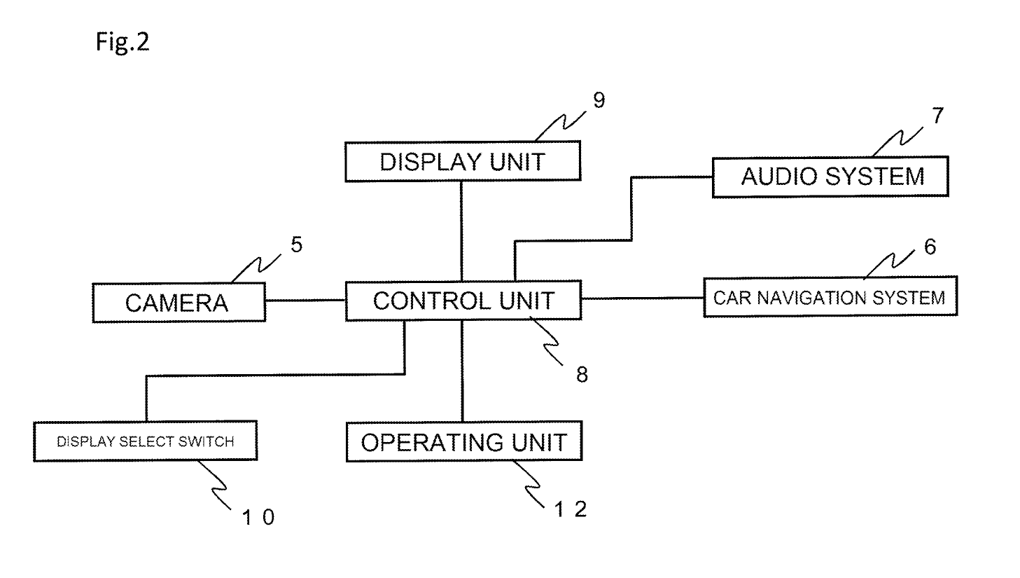

FIG. 2 is a control block diagram of the vehicle-mounted electronic equipment operation device according to the present invention. As illustrated in FIG. 2, the electronic equipment 4 includes a car navigation system 6, an audio system 7, or the like. The car navigation system 6 and the audio system 7 are connected to a control unit 8.

Further, the display unit 9, the above-described camera 5 and a display select switch 10 are connected to the control unit 8.

Still further, an operating unit 12 is also connected to the control unit 8. The operating unit 12, when being connected as illustrated in FIG. 2, is intended to operate the car navigation system 6 and the audio system 7. As will be described later, operating items provided in the operating unit 12 are displayed in the display unit 9 through the control unit 8.

It should be noted that the display select switch 10 is provided at the handle 3 as illustrated in FIG. 1.

The control unit 8 of the vehicle-mounted electronic equipment operation device according to the present invention has a function of displaying the operating unit 12 at at least part of an outer peripheral portion of the display unit 9 and displaying an image from the camera 5 at a central portion of the display unit 9.

As will be described later, when the control unit 8 displays the operating unit 12 at at least part of the outer peripheral portion of the display unit 9 by way of operation of the display select switch 10, the control unit 8 also displays the image from the camera 5 at the central portion of the display unit 9. Here, brightness of the image (camera image) from the camera 5 to be displayed at the display unit 9 is lowered at an initial stage of the display, and increased afterward.

It should be understood that the control unit 8 can also display a navigation image at the display unit 9. The vehicle-mounted electronic equipment operation device according to the present invention may be configured so that when an image to be displayed at the display unit 9 is switched from an image from the car navigation system 6 (navigation image) to an image corresponding to an item selected at the operating unit 12 (operating unit image), brightness of the camera image to be displayed at the central portion of the display unit 9 is lowered, and increased afterward.

It should be noted that the display of the operating unit 12 at the outer periphery of the display unit 9 is substantially constant unless it is necessary to change the brightness.

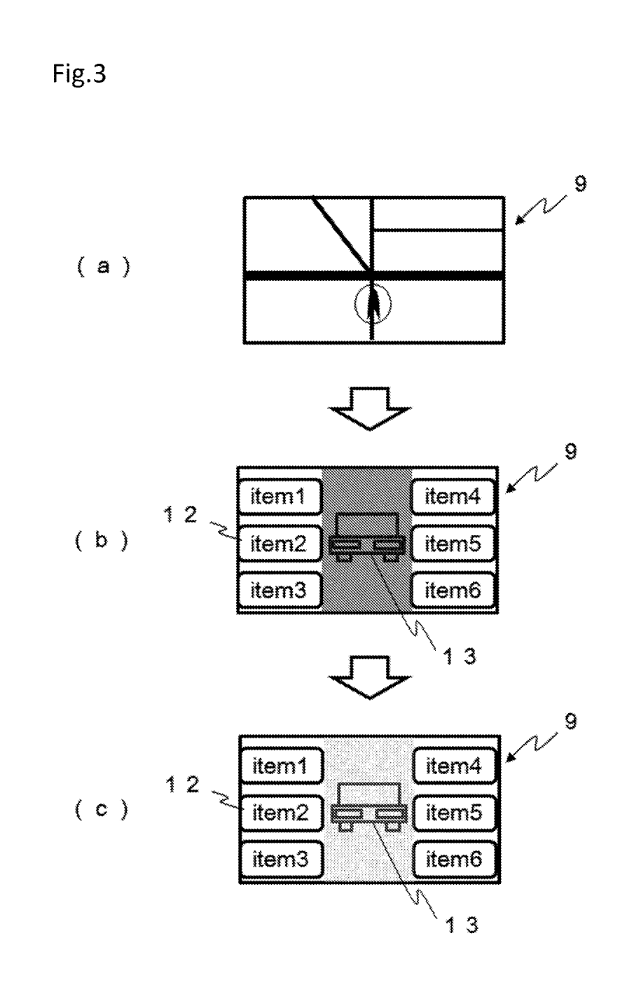

FIG. 3 is a diagram schematically explaining route guidance display by the car navigation system 6 (FIG. 3(a)) displayed at the display unit 9, initial display of the camera image displayed at the display unit 9 (FIG. 3(b)), and display after the brightness of the camera image is increased displayed at the display unit 9 (FIG. 3(c)).

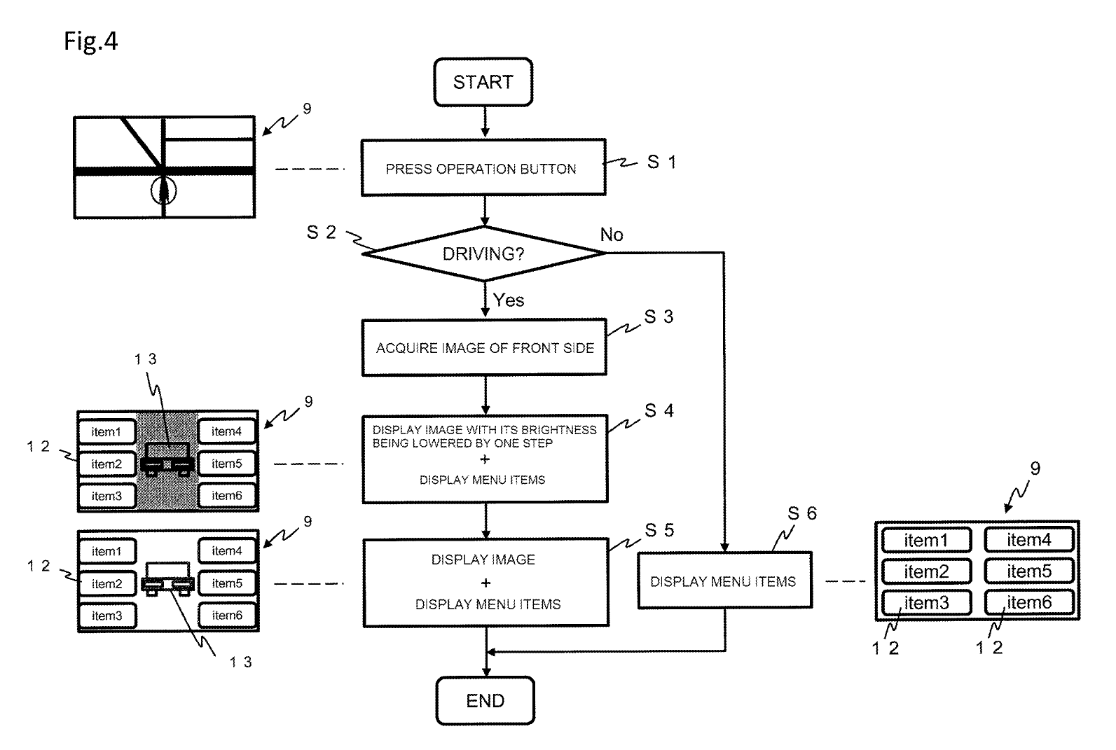

Further, FIG. 4 is a flowchart for explaining operation of the vehicle-mounted electronic equipment operation device according to the present invention. FIG. 4 illustrates the route guidance image, the camera image at the initial stage of the display and the camera image after the brightness is increased illustrated in FIG. 3 in association with respective display steps.

The operation of the vehicle-mounted electronic equipment operation device according to the present invention will be described below with reference to FIG. 3 and FIG. 4.

In the above-described configuration, while the vehicle 1 is driving, the route guidance display by the car navigation system 6 is displayed at the display unit 9 as illustrated in FIG. 3(a).

Here, when the driver operates the display select switch 10 at the handle 3 to operate, for example, the audio system 7 (S1), the control unit 8 determines whether or not the vehicle 1 is driving based on, for example, information from the car navigation system 6, an image from the camera 5 and information from the vehicle (S2).

When it is determined that the vehicle is driving in step S2 (S2: Yes), the control unit 8 acquires an image of the front side of the vehicle from the camera 5 (S3), and, subsequently, as illustrated in FIG. 3(b), displays menu items (operating items) of the operating unit 12 at both sides (at least part of the outer peripheral portion) of the display unit 9 and displays the image of the front side from the camera 5 at the central portion of the display unit 9 while lowering brightness of (dimming) the image of the front side (S4).

That is, in this embodiment, the control unit 8 displays the operating unit 12 at at least part of the outer peripheral portion of the display unit 9 by way of the operation of the display select switch 10, and when the control unit 8 displays the image from the camera 5 at the central portion of the display unit 9, lowers the brightness of the camera image 13 at the initial stage of the display of the camera image 13.

After several seconds have elapsed since the initial stage of the display of the camera image 13, the brightness of the camera image 13 is gradually increased, and, as illustrated in FIG. 3(c), the camera image 13 after the brightness is increased is displayed along with the menu items (operating items) of the operating unit 12 (S5).

That is, because the brightness of the camera image 13 is gradually increased after the operation of the display select switch 10, even when an image of the sun at the front side of the vehicle is displayed or an image of a head light of a vehicle coming from the opposite direction is displayed, the driver gets relief from dazzle, and as a result, it is possible to improve safety.

Further, when the driver operates the operating unit 12 in a state where the image is displayed as illustrated in FIG. 3(c), because the camera image 13 with its brightness being restored is displayed at the central portion of the display unit 9, the driver can operate the operating unit 12 safely while well confirming a situation of the front side.

It should be noted that when it is determined that the vehicle is not driving in step S2 in FIG. 4 (S2: No), only the operating unit 12 (only the menu items) is displayed at the display unit 9, and the camera image 13 is not displayed (S6).

Further, in such a situation, the size of the display of the menu items is increased compared to a case where the camera image 13 is displayed so as to improve visibility for the driver by effectively utilizing a display area of the display unit 9.

Further, the brightness of the display of the operating unit 12 (display of the menu items) at the outer peripheral portion of the display unit 9 is substantially constant regardless of whether the camera image displayed at the display unit 9 is at the initial stage of the display (FIG. 3(b)) or after the brightness is increased (FIG. 3(c)). Accordingly, the display of the operating unit 12 is stable and has favorable operability.

### INDUSTRIAL APPLICABILITY

As described above, in the present invention, because brightness of a camera image is lowered at an initial stage of display of the camera image, and increased afterward, a driver is less likely to feel that the image is too bright, and as a result, it is possible to improve safety.

Accordingly, the present invention is expected to be applied as various vehicle-mounted electronic equipment operation devices.

### REFERENCE SIGNS LIST

1 Vehicle
2 Vehicle interior
3 Handle
4 Electronic equipment
5 Camera
6 Car navigation system
7 Audio system
8 Control unit
9 Display unit
10 Display select switch
12 Operating unit
13 Camera image

1-3. (canceled)

4. A vehicle-mounted electronic equipment operation device comprising:
a display unit;
a control unit connected to the display unit; and
a camera and a display select switch connected to the control unit,
wherein the control unit has a function of displaying an operating unit at at least part of an outer peripheral portion of the display unit and displaying an image from the camera at a central portion of the display unit, and
when the control unit displays the operating unit at at least part of the outer peripheral portion of the display unit by way of operation of the display select switch, the control unit also displays the image from the camera at the central portion of the display unit, while lowering brightness of the camera image at an initial stage of display of the camera image and increasing the brightness afterward.

5. The vehicle-mounted electronic equipment operation device according to claim 44, wherein the brightness of display of the operating unit at the outer peripheral portion of the display unit is made substantially constant.

6. The vehicle-mounted electronic equipment operation device according to claim 44, wherein the control unit displays a navigation image at the display unit, and, when the navigation image is switched to an image of the operating unit, the brightness of the camera image to be displayed at the central portion of the display unit is lowered and increased afterward.

7. The vehicle-mounted electronic equipment operation device according to claim 3, wherein the brightness of display of the operating unit at the outer peripheral portion of the display unit is made substantially constant.
